(19) United States
(12) Patent Application Publication
(10) Pub. No.: US 2016/0093005 A1
(43) Pub. Date: Mar. 31, 2016

(54) Ordering System

(71) Applicant: WI-Q LIMITED, Essex (GB)

(72) Inventor: Graham Cornhill, Great Horkesley (GB)

(21) Appl. No.: 14/893,200

(22) PCT Filed: May 22, 2014
(86) PCT No.: PCT/GB2014/051581

§ 371 Date: Nov. 23, 2015

(30) Foreign Application Priority Data
May 23, 2013 (GB) 1309332.3

(51) Int. Cl. G06Q 50/12; G06Q 30/06; G06Q 30/02

(52) U.S. Cl. CPC G06Q 50/12; G06Q 30/0267; G06Q 30/0633; H04W 84/12

(57) ABSTRACT

Ordering system and method comprising a server connectable to a wireless access point and configured to transmit from the wireless access point a menu of products to a mobile device, process a communication from the mobile device received by the wireless access point, the communication including one or more products selected by a user, and generate an order instruction comprising the selected one or more products.

### FIELD OF THE INVENTION

The present invention relates to an ordering system and method and in particular to an ordering system and method for use in bars, restaurants and hotels.

### BACKGROUND OF THE INVENTION

Ordering food, drinks and other products in a hotel environment requires guests to go directly to bars or restaurants (or other outlets) within the hotel in order to make an order. Alternatively, staff may be required to walk around and take orders from hotel guests as and when they are required. However, a hotel guest may be relaxing by a pool, for example, and may not want to get up to make their order. Furthermore, staff may not be available for a guest at that particular time. Therefore, the guest may instead decide not to place an order leading to lost revenue to the hotel.

Similarly, ordering food or drinks in a restaurant or similar establishment requires waiting staff to visit each table or for customers to visit a bar. Once an order is made, then any additional food or drink will require a new order to be made in a similar way. This is either inconvenient for the customer or requires high staffing levels, both of which can lead to lower revenues and lower customer satisfaction levels.

Therefore, there is required a system and method that overcomes these problems.

### SUMMARY OF THE INVENTION

Against this background and in accordance with a first aspect there is provided an ordering system comprising:

a wireless access point;

a server in communication with the wireless access point and configured to transmit from the wireless access point a menu of products to a mobile device, process a communication from the mobile device received by the wireless access point, the communication including one or more products selected by a user, and generate an order instruction comprising the selected one or more products. Therefore, orders may be placed more conveniently and efficiently. The user may be a staff member but preferably a customer or guest. The customer or guest can place their order using their own mobile device (e.g. smartphone) without needing to go to an order point (e.g. bar) and without requiring the attendance of a staff member. The server may be a web server, for example. The products may include both goods and services.

Preferably, the ordering system may further comprise a wireless access point. The wireless access point may be internal, i.e. within the same device that operates the server or web server or may be external, i.e. connected by a wired or wireless connection to a device or computer that operates the server. The wireless access point is a device that allows wireless devices to connect to a wired network (e.g. an intranet or the internet) using WiFi or similar protocols.

Optionally, the wireless access point may be configured to provide internet access to the mobile device. Therefore, the user may be encouraged to use the system (i.e. to take advantage of the internet access) by being presented with the menu.

Preferably, wherein the wireless access point may be configured to automatically direct the mobile device to the menu of products, following a wireless connection to the wireless access point. This may use a captive portal technique, for example.

Preferably, the wireless access point may be a WiFi or 802.11 standard access point or another type of access point used to provided wireless connectivity to the mobile device.

Preferably, the server or web server may be further configured to a process payment initiated by the user on the mobile device for the one or more selected products. Therefore, payment may be made at the time of order. This further increases the efficiency of the process as a separate payment step is not required once the product or products have been received by the customer. The payment may be processed by a credit/debit card transaction, adding to an existing account (e.g. room number) or other payment mechanism, for example.

Optionally, a confirmation of the payment may be received with the communication. This allows the seller or establishment to know that they have been paid before accepting the order.

Optionally, the ordering system may further comprise an interface with an electronic point of sale, EPOS system, wherein the EPOS system is configured to process the generated order instruction. This further automates order processing and payment as well as accounting and stock control procedures.

Preferably, the menu of products may be transmitted in a format renderable on a browser on the mobile device. This may be a built in or default browser, for example.

Optionally, the ordering system according may further comprise a printer configured to print the generated order instruction.

Preferably, the menu of products may be configurable. This menu may also be continually updated, preferably in real-time.

Preferably, the order of the products appearing on the menu may be configurable.

Optionally, the products may be any one or more selected from the group consisting: food, beverages, music, concierge services, and taxi services. Other products, including services, may be ordered or requested.

Optionally, the menu of products is configurable by the user or server to exclude or include one or more categories of products. Such options may be selectable by the user, for example.

Optionally, one or more categories of products may include, nut containing, vegetarian, alcoholic, non-alcoholic, low fat, low calorie, and low or no sugar.

Optionally, the server or web server may be further configured to present advertisements on the mobile device together with the menu of products. Therefore, the user may be encouraged to view advertisements when using the system.

Optionally, the server or web server may be further configured to provide to the mobile device a calorie count of the one or more selected products. The calorie count may be a sum of the products selected.

Preferably, the communication may further contain a table or location identifier to receive the ordered products. Therefore, the order may be delivered to the correct customer when complete. The user may add their location, table or seat number/identifier when placing their order, for example.

Optionally, the server or web server may be further configured to restrict the menu of products to those products currently available and/or in stock.

Preferably, the mobile device may be selected from the group consisting of: cell phone, smartphone, tablet computer, and laptop computer. Other mobile device types may be used.

Preferably, the user may be a consumer or customer of the one or more products. The user may also be an employee such as a waiter, for example.

Optionally, the server or web server may be further configured to present a separate web page for separate users such that each separate user may build a separate sub-order of products to be added to the communication. In other words, a single order may be placed or formed from individual sub-orders for each person in a party. The server or web server may generate an option to take a new sub-order from each person and display their choices as they make their selection. Once a person is happy with their order then they may pass the mobile device to another person who may create a new sub-order. When no more sub-orders are necessary or after every person in a party has created a sub-order, then the mobile device may be passed back to a main user or customer to send the complete order as a communication or web response back to the server or web server. The user that completes the full or total order may also make the payment to cover the cost for all sub-orders.

Optionally, each sub-order may have an associated cost presented to each separate user. This may be in the form of a running sub-total for the products that they have selected.

According to a second aspect, there is provided a method for receiving an order from a user, the method comprising the steps of:

transmitting from a wireless access point a menu of products, the menu being renderable on a browser of a mobile device;

receiving from the mobile device a communication including one or more products selected by a user; and

generating an order instruction comprising the selected one or more products.

The methods described above may be implemented as a computer program comprising program instructions to operate a computer. The computer program may be stored on a computer-readable medium.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of an ordering system, given by way of example only;

FIG. 2 shows a schematic diagram of a further embodiment of the ordering system of FIG. 1;

FIG. 3 shows a schematic diagram of a further embodiment of the ordering system of FIG. 1;

FIG. 4 shows a flowchart of a method for placing an order, given by way of example only;

FIG. 5 shows a schematic diagram of a further example ordering system including initial processing steps;

FIG. 6 shows a schematic diagram of a further example ordering system including further processing steps; and

FIG. 7 shows a schematic diagram of a further example ordering system including completion processing steps.

It should be noted that the figures are illustrated for simplicity and are not necessarily drawn to scale.

### DETAILED DESCRIPTION OF THE PREFERRED EMBODIMENTS

The described system and method may be implemented as a combination of software and hardware that allows customers to order products directly from any WiFi enabled device using an electronic version of an establishment's menu. The order may then be directed to an electronic point of sale system for processing. This can reduce or remove the requirement for staff to take orders.

A computer, with an attached receipt printer, may operate as a web server on a wireless network. The computer executes an application that serves an establishment's menu to allow customers to create an order from their mobile device. The order may be sent as a communication from the mobile device to the web server using a standard web protocol such as HTTP, for example. The order may be processed and printed directly from the receipt printer. The ordering system and software may integrate directly with the establishment's electronic point of sale (ePOS) system. The system therefore creates an e-commerce environment local to an establishment which they can control quickly and dynamically enabling greater flexibility of menus. This allows the establishment to influence what the user sees on the menu, for example, removing products which are ‘out of stock’.

The term ‘back-end’ may be defined as a program running on a server, which builds responses to an HTTP request.

The term ‘client’ is to be defined as the application running on the device the user is using; for example a smartphone, or a tablet etc. The client may be implemented as a browser on a mobile device.

To serve requests from a client or browser, the server may run an open source HTTP server known as Apache. The back-end logic has been implemented with PHP. The jQuery mobile framework has been implemented as a base layer for the client side application. Receipts may be printed using a standard thermal receipt printer.

Benefits of the system include:

Putting the menu in the users' hands, therefore removing the need for a member of staff to collect their order.

Works with all wireless devices which are able to render web pages and execute javascript.

Does not need an existing IT infrastructure to function. It may be entirely self contained, however, it can be integrated into an existing IT infrastructure if required.

May integrate directly into ePOS systems.

Provides the ability for a user to request assistance without trying to physically get a member of staff's attention.

Provides the site owner with the ability to change their menus in real-time. Using a simple administrator interface the site owner can easily change the products which are displayed, reorder the menus to help promote items as well as quickly being able to add and remove products and categories.

Can be used by both customers and staff to place orders.

Allows an establishment to present the user with a list of up-sells products which could be missed/forgotten when served conventionally.

Provides the ability to add adverts dynamically throughout the menu.

Can be setup to provide dietary requirement specific menus. For example, automatically removing products which contain nuts if a user has a nut allergy.

Can be setup to provide Calorie Counting functionality showing the user nutritional information regarding their order.

Provides the ability for an establishment to provide their menus in multiple languages in addition to the existing multilingual interface.

May be used to implement a loyalty rewards system by recognising devices that visit an establishment multiple times.

Enhances the customers experience through any of the following:

Out of stock control

Voucher codes on checkout

Pay bill button by PayPal, Google, Cash, Card

Request/capture customer information to returning customers and remarketing

Stake slider to indicate cooking instructions

Multi Language

Pick Music—Request a song from the DJ/Jukebox

Audio Menu

Venue information i.e. where is the toilet?

Concierge Service

Remember order for next time you come to the venue

Social networking may allow users to find other users

Pictures of dishes

Ordering items to other people's tables as gifts

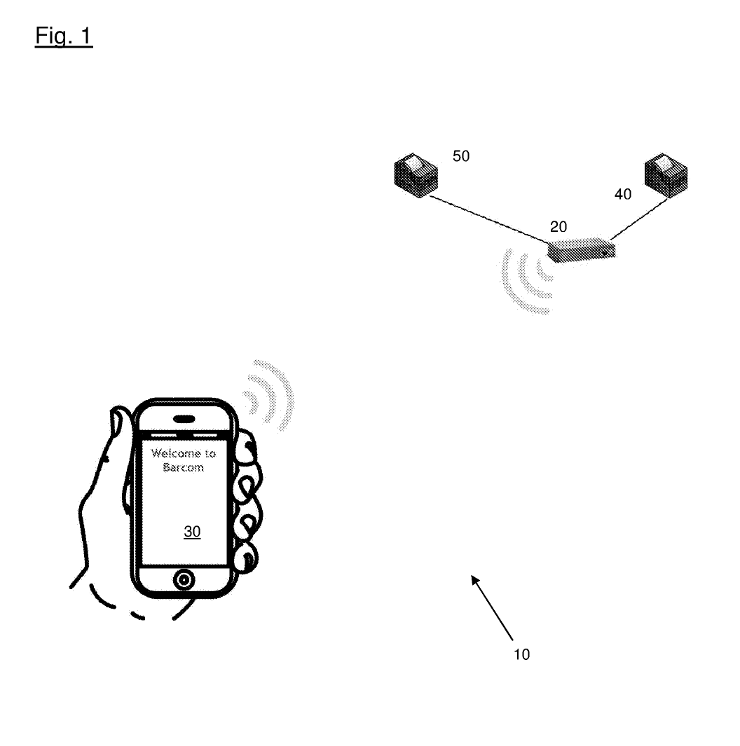

FIG. 1 illustrates schematically the ordering system 10. A self-contained server 20 (or a server or a device) comprises a web server and wireless access point. The wireless access point broadcasts its Service Set Identifier (SSID), which provides a wireless network name that a mobile device 30 may locate and join as a new wireless network (for example through the iOS Settings>Wi-Fi>Choose a Network. menu).

Once the wireless network has been selected and added for use by the mobile device, then the web server within the self-contained server 20 implements a captive portal procedure in order to automatically launch a browser on the mobile device 30 and direct the browser to a home page provided by the web server. Communication between the browser on the mobile device 30 and the web server may be through standard internet protocols (e.g. HTTP, HTTPS, etc.)

The self-contained server 20 may be connected to one or more printers 40, 50 that allow processed orders to be printed so that they may be fulfilled by and establishment. The printers 40, 50 may be located in restaurants and bars of the establishment, for example. The printers may be connected to the self-contained server 20 directly or through a network (e.g. wireless or Ethernet). The mobile device 30 may operate using a suitable operating system such as iOS or Android, for example.

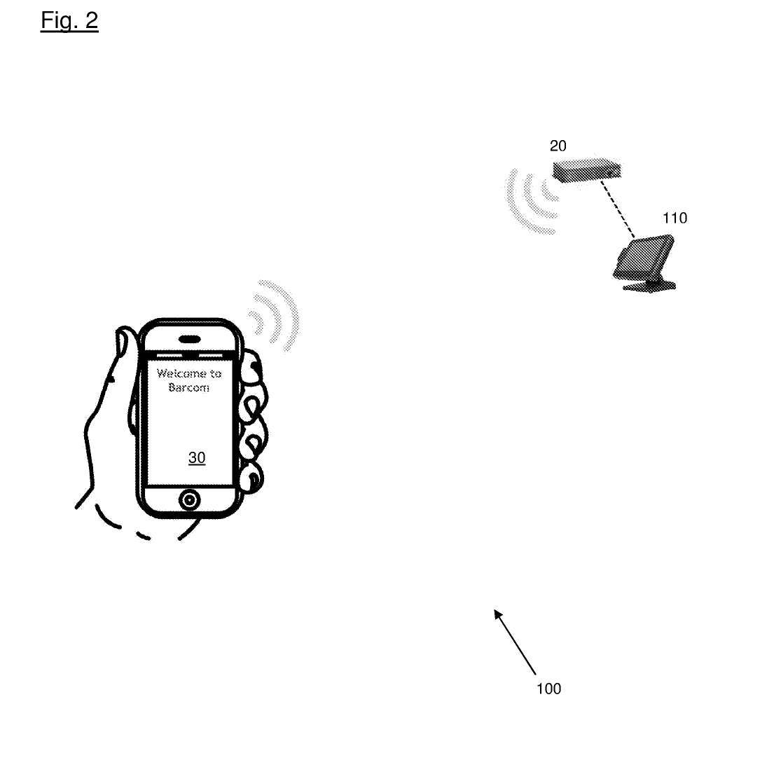

FIG. 2 illustrates a further embodiment of the ordering system 100. The self-contained server 20 also contains the same web server and wireless access point as described with reference to FIG. 1. However, in this further embodiment, the self-contained server 20 is connected to an ePOS system 110. This ePOS system 110 may accept orders in the conventional way or accept orders from the self-contained server 20 to be similarly processed. The ePOS system 110 may be conventional and accept, record and process sales for the establishment. However, instead of using a dedicated terminal to receive details of any order, the ePOS system 110 receives the order from the self-contained server 20 in a suitable electronic format.

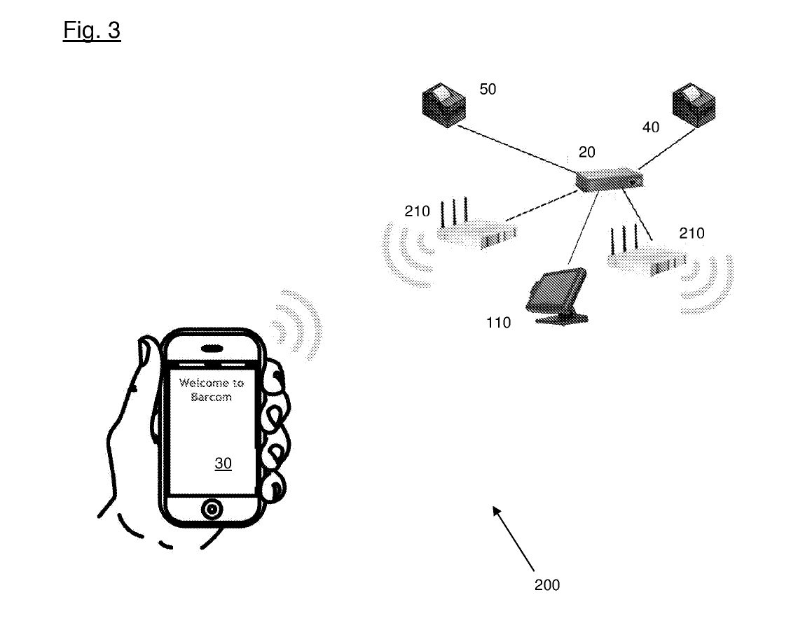

FIG. 3 shows a further example embodiment 200 in which the self-contained server 20 is connected to external wireless access points 210 that may be used to extend wireless coverage. Furthermore, these external wireless access points 210 may also provide internet access as well as the menu and ordering services to the mobile device 30. There may be one or more external wireless access points 210 although two are shown in FIG. 3. Obviously, more than one mobile device 30 may be connected to the system of any of the embodiments described. Orders may be received simultaneously. Furthermore, the self-contained server 20 may be connected to existing infrastructure within an establishment.

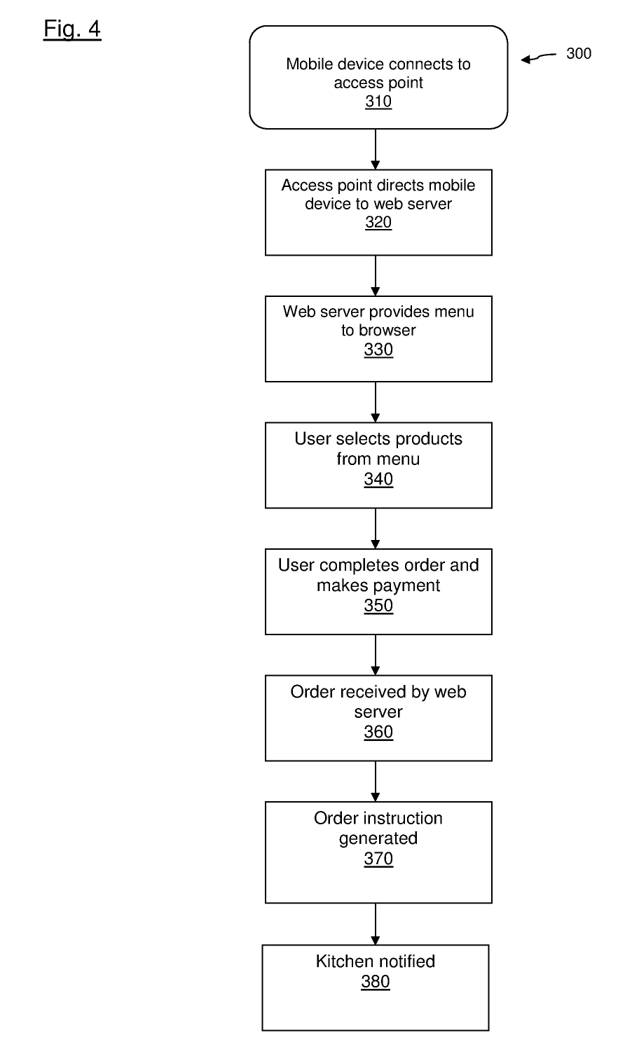

FIG. 4 shows a flow diagram describing a method for ordering products using the systems 10, 100 and 200 described with reference to FIGS. 1 to 3. A user (customer or possibly an employee) may search for available wireless networks using their mobile device 30. Once the user has selected the wireless network associated with the ordering system, then their mobile device 30 will connect to the network. Typically, this will not require a password before the mobile device connects to the access point at step 310.

Upon connection, the wireless access point directs the mobile device to a web page provided by the web server within the self-contained server 20 at step 320. The mobile device 30 is therefore automatically directed to launch a browser in order to render the web page (home page or launch page).

Either at this initial first web page or following a user selection, the web server provides a menu of products to the browser at step 330. Such logic may be implemented using PHP, for example. This web page (containing a menu of products) provides the user with the ability to select products in order to build an order similar to the way that an online store allows a customer to fill an online basket. In this way, the user selects products from the menu at step 340. Once all required products have been selected from the menu, then the user may complete the order and make a payment at step 350. This may be by using a credit card, debit card or other payment mechanism. Alternatively, the user may confirm that they wish to debit an existing account within the establishment. For example, this may be confirmation that the order should be added to a particular room number or table number. Security mechanisms such as passwords, may be implemented in order to prevent the order from being associated with the wrong account.

As the order is being billed or upon completion of the order, then one or more communications may be sent from the mobile device 30 to the web server providing details of the requested order and other information. One or more communications may also include the payment or confirmation of payment. The communication may comprise multiple two-way signals between the mobile device 30 and the web server. Therefore, the order may be received by the web server at step 360 either in several parts forming a single communication. Once the web server has received the order details, then it may generate an order instruction at step 370. The kitchen (or bar), for example, may be notified at step 380. Notification may be by electronic form or by printing a paper copy of the order on printers 40, 50 to be picked up and processed by staff. Once complete, the ordered products may be dispatched for delivery to the customer.

The order may be built by the user selecting individual items, as described above. Alternatively, and especially where there are several members of a party, each order may comprise sub-orders selected by each individual. The sub-orders may be consolidated and paid for together in a single payment and the order instruction may comprise a single consolidated order.

The web page provided by the web server may include functionality facilitating generation of the sub-orders. For example, the mobile device 30 may be passed between individuals to enter their own selected products (or apply filters and other preferences, as required). Once an individual has selected their products then they may indicate on the web page that their sub-order is complete and pass the mobile device 30 to another individual to repeat the process. Once every member who requires products has added their sub-order then the web page may prompt to confirm that no further sub-orders are required. The main customer or user may then pay for the order and the full order and any payment confirmation message will be sent to the web server and completed as previously described.

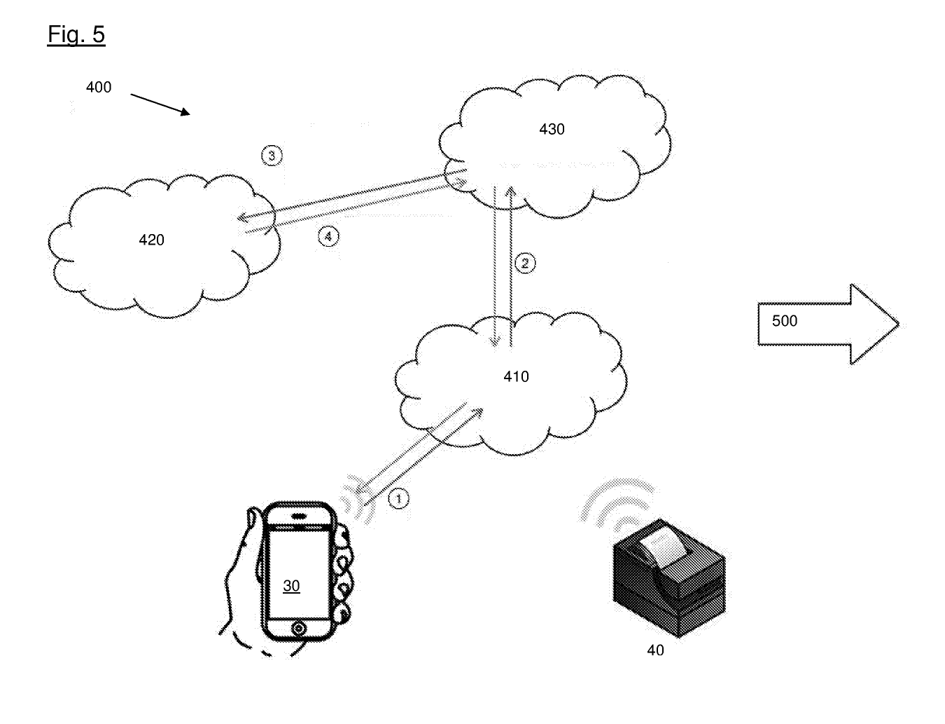

In the previous embodiments, the server or self-contained server 20 has been shown as being connected to the wireless access point 210. This connection may be achieved over a network, wired or wirelessly. The server 20 may be situated local to the wireless access point 210 or incorporated within it. The server 20 may also be remote from the wireless access point or not located within the same environment. Furthermore, the server 20 may be a virtual or cloud-based server such as one provided by Amazon Web Services, for example. FIG. 5 illustrates schematically the use of a remote or cloud-based server 420.

The user of the mobile device 30 joins the wireless access point 410 as described previously. Once set up and directed to the relevant web page, the user may send a request 1 to create an order. The wireless access point (that may be a general purpose wireless access point, a dedicated wireless access point or a public WiFi hotspot, for example) forwards the communications with the mobile device 30 on to the Internet 430 or hotspot backbone. This communications traffic may be routed 2 as an HTTP request, for example.

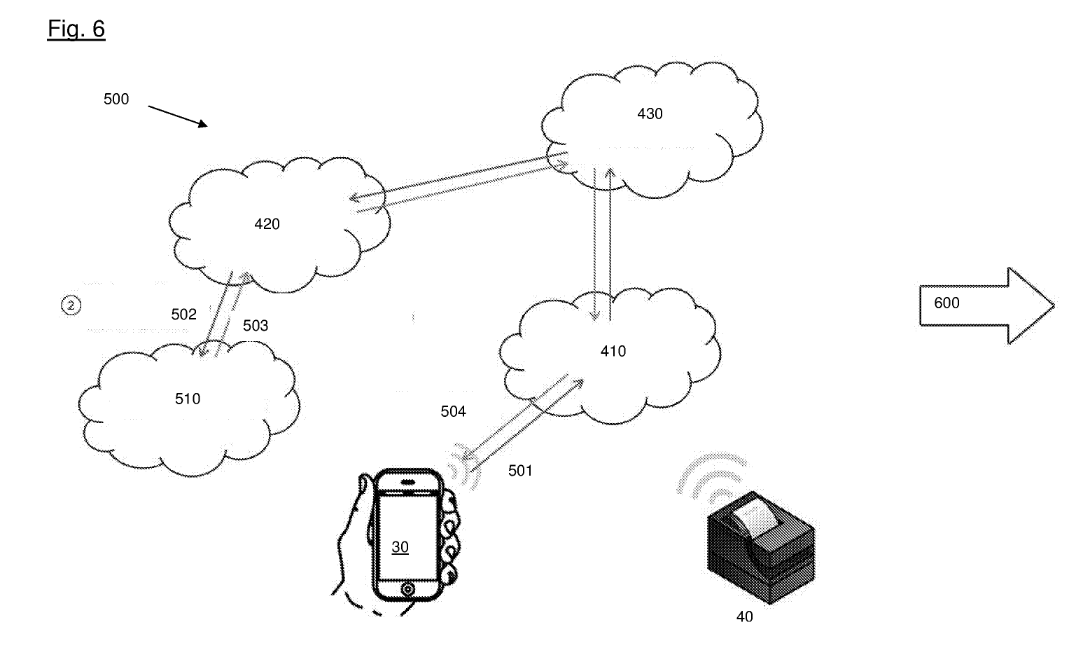

A domain name server (DNS) in the Internet 430 or hotspot backbone may then route 3 the communications traffic to the server 420. In response to the request to create an order 1 or start the ordering process then the server 420 may respond by providing the menu back to the mobile device 30. This menu may be returned along the same route as the request, as illustrated in FIG. 5. The order may be built by the user as described previously with the order request, following the same communications route as the menu request. The procedure continues to the payment stage 500 as illustrated in FIG. 6.

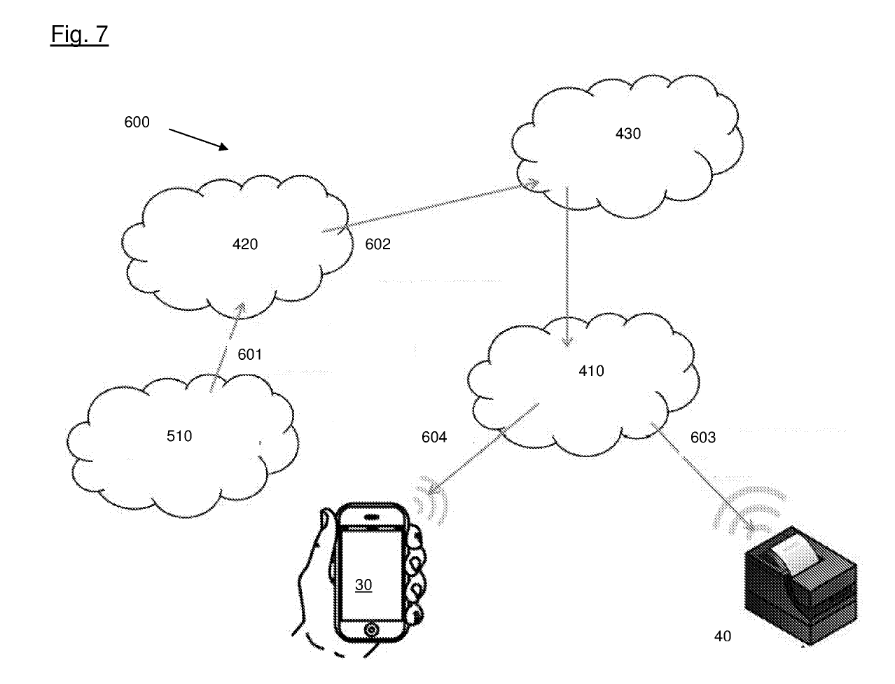

The user issues a request 501 to make a payment for their order by card (e.g. debit or credit card). This is passed on to the server 420 in a similar way and communications route to that described for the earlier requests. Transaction details of the payment are sent from the server 420 to a payment gateway 510 (arrow 502). This may be a payment service provided by an external provider, for example. The payment gateway 510 securely responds 503 to the transaction details (e.g. using SSL) by generating an iFrame or other encapsulation means, including functionality enabling the user to make the payment. The iFrame is presented to the user 504 after being routed through the Internet 430 and wireless access point 410. The user may then confirm the payment on the iFrame, which is processed by the payment gateway 510. The procedure continues to order print stage 600, as illustrated schematically in FIG. 7.

Once the payment gateway 510 confirms 601 to the server 420 that the payment has processed successfully then the server 420 generates a printing request 602 for the order. This is routed back to the wireless access point 410 over the Internet 430. The wireless access point 410 is connected to one or more printers 40. The order is received, printed and processed by the printer 40 so that the goods or services may be prepared according to the requested order.

Alternatively, the order is sent directly to the printer or via a further device (e.g. a POS system). Whilst printing the order is advantageous, it may simply be displayed on a screen. The order information may be conveyed by other means, such as electronically for example.

At the same or similar time, the mobile device 30 may be provided with an acknowledgement of payment and order receipt (604).

The following provides an overview of an example workflow process and variations for receiving and processing orders. This workflow provides specific examples and products but may be extended and used with any other products or services.

1) Customer enters an establishment

2) Customer connects to Wi-Fi
a. The Wi-Fi will either be a dedicated SSID (wireless network name)
b. Or the venue's own SSID
c. Or a cloud based supplier

3) Customer navigates server (e.g. http://barcom./)
a. If using a dedicated SSID then ALL traffic is routed to a landing page (e.g. Order Pay and Go OPG)
   i. Order Pay and Go server—online or cloud server
   ii. Order Pay and Go server—local server within the venue
b. If the user is access the venue's own SSID then all communications traffic for the order system is routed to the OPG server with the use of DNS (both for local and online or cloud server)
c. Where the online or cloud based server is being used then the OPG will be served remotely. In this scenario the venue may use a hosted service (i.e. a central hub) and only the printer is required within the venue

4) Customer reviews the T&C and accepts presented to the user
a. Distance selling T&C's
b. Mechanism to prevent customers placing “fake” orders
c. Provide explanation that the service provides a conduit to the venue, which is otherwise responsible for the delivery of the product or service

5) Customer enters order details
a. Table Number
   i. uniquely identifies the customers location
   ii. enters surname for takeaway orders
   iii. enters room number for Room Service in a hotel
   iv. enters room number for Room Service in a conference centre
b. Loyalty card number
   i. The venue may have a loyalty scheme that can be utilised
   ii. Create a loyalty scheme specific to the present service (OPG)
c. Number of people ordering from this device
   i. If in a group but one member of the group is paying for everyone this may enable them to create the order on their separate mobile devices and have one user receive the total and pay for the order
d. Name each person
   i. Easy identification of each person's order when reviewing the basket
   ii. Break down of costs for each person
   iii. Provides a personal service when delivering the food, e.g. “Joe's Meal”

6) Customer presented with menu
a. Dynamic menu
   i. depending on time of day, e.g. lunch menu
   ii. day of the week e.g. Sunday roast
   iii. out of stock control e.g. once a dish is gone it doesn't show on the menu
   iv. move short dated items to the top of the list
b. Menu sorting
   i. Move short dates items to the top
   ii. Move new dishes to the top
c. Special menus e.g. mother's day, valentine's day
d. Only show vegetarian, glutton free etc. menu items
   i. This may be a simple tick box that users select and instantly removes these items from the menu
e. Nutritional information on each product
   i. Calories, fat etc.
   ii. Ingredients
f. Upsell and cross sell of products
   i. Upsell on a product, e.g. add bacon to a burger
   ii. Add additional sides, e.g. add onion rings
   iii. After adding a coffee, ask if they would like a cake
g. Search
   i. Users can search for keywords on any dish, e.g. chicken and it will show only where that word appears
h. Feedback surveys
i. Advertising space
   i. There is space for adverts to run on the users screen
   ii. This could advertise brands as well as events in the venue, e.g. mother's day
   iii. Adverts can be linked to pages in the menu.
j. Collect the users' mobile number as their login information
k. Request/capture customer information
   i. Allowing remarketing
   ii. Allowing customers to view what they had last time they came to the venue
   iii. Allowing customers to save favourites
l. Comments to the work area
   i. Allowing the customer to state specific requirements like “no Mayo”
   ii. Stake slider to indicate cooking instructions on stake
m. Multi Language
   i. Dynamically switch to the customers native tongue (e.g. set by preferences)
n. Accessible menu for people with disabilities
   i. Audio Menu—Talks it to you.
   ii. Large Print—Be able to zoom the menu
o. Calorie Counting
   i. if on a diet and you only have 800 calories left, allow the system to suggest meals within this allowance
   ii. show me all mains under 400 calories
p. Concierge Service
   i. Venue information, e.g. where is the toilet?
   ii. Local taxi numbers
   iii. Request a receipt
   iv. Call a waitress
   v. Request the bill (if paying by cash)
q. Pictures of dishes
r. Review dishes
   i. Allow users to add a review to the dish and show the rating when ordering
s. Reminders
   i. If buying a time based service such as Car Parks Payments and reminds when you ticket is up, as well as allowing you to renew it.
t. Online Account for tracking purchases
   i. Have a community website where you can login and review your orders ideal for a “business person” to collect receipts
u. Recommended meals when you enter a new enabled venue
   i. “customers that bought a coffee in Costa bought a Ham sub in Subway”
v. Remote ordering
   i. We have all venue menus. These may be made available online and allow remote or take away ordering to be done direct in to the till. For example, while walking to a pub you may order your pint and pay for it ready for when you arrive
w. Pick Music—Request a song from the DJ/Jukebox

7) Customer creates an order
a. The customer can add items to their basket
b. When adding an item they can send notes to the venue i.e. “no mayo”

8) Customer reviews and confirms their order
a. The customer is shown their completed order
b. The customer can then edit the order
c. Once complete, confirms and hands the device to the next user if ordering from one device.

9) Customer reviews the whole order
a. The customer then reviews the whole order
b. Service charge is then added (if required)
c. Voucher codes can be entered
d. The customer then reviews and confirms the order

10) Customer selects payment method
a. The customer can pay by Cash
   i. In which case the order is sent though and they pay on exit
b. The customer can pay by Card
   i. The customer is then taken to a secure page where they enter their card details
   ii. They then have to complete 3D secure or other similar secure payment system
   iii. If the transaction is successful the user's card is optionally stored for next time
   iv. If the user already has a card stored, then they just click that card name and enter the CV2 to confirm identity
c. The customer can pay by PayPal
   i. Customer is the taken to PayPal to login
   ii. Once the transaction is complete they are taken back to a confirmation screen

11) Customer's order is sent to the venue
a. The order is printed directly in to the venue's work area, e.g. kitchen
b. Or the order is displayed Touch Screen device to allow them to manage the order digitally
c. Have a text back service to allow collection of orders as well as table service

12) Customer can then give feedback on their order
a. Share on social media
b. Answer questionnaires about the service
c. Rate the meal

It should be noted that any feature described with respect to one embodiment may be part of any of the other described embodiments.

As will be appreciated by the skilled person, details of the above embodiment may be varied without departing from the scope of the present invention, as defined by the appended claims.

For example, the products may include goods and/or services. Prices and other product information may also be provided. Staff as well as customers may use the mobile device. Instead of a web page, the mobile device 30 may run a mobile application as a client with similar functionality. In this case, the web server may be replaced with a server to interact with the mobile application.

Example mobile devices include mobile telephones, smartphones and other user equipment, laptop computers and tablet computers, for example.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. An ordering system comprising:
a server connectable to a wireless access point and configured to transmit from the wireless access point a menu of products to a mobile device, process a communication from the mobile device received by the wireless access point, the communication including one or more products selected by a user, and generate an order instruction comprising the selected one or more products.

2. The ordering system of claim 1, further comprising a wireless access point.

3. The ordering system of claim 2, wherein the wireless access point is configured to provide Internet access to the mobile device.

4. The ordering system according to claim 2 or claim 3, wherein the wireless access point is configured to automatically direct the mobile device to the menu of products following a wireless connection to the wireless access point.

5. The ordering system according to any of claims 2 to 4, wherein the wireless access point is a WiFi or 802.11 standard access point.

6. The ordering system according to any previous claim, wherein the server is further configured to a process payment initiated by the user on the mobile device for the one or more selected products.

7. The ordering system of claim 6, wherein a confirmation of the payment is received with the communication.

8. The ordering system according to any previous claim further comprising an interface with an electronic point of sale, ePOS system, wherein the EPOS system is configured to process the generated order instruction.

9. The ordering system according to any previous claim, wherein the menu of products is transmitted in a format renderable on a browser on the mobile device.

10. The ordering system according to any previous claim further comprising a printer configured to print the generated order instruction.

11. The ordering system according to any previous claim, wherein the menu of products is configurable.

12. The ordering system of claim 11, wherein the order of the products appearing on the menu is configurable.

13. The ordering system according to any previous claim, wherein the products are of any one or more selected from the group consisting: food, beverages, music, concierge services, and taxi services.

14. The ordering system according to any previous claim, wherein the menu of products is configurable by the user or server to exclude or include one or more categories of products.

15. The ordering system of claim 12, wherein the one or more categories of products include, nut containing, vegetarian, alcoholic, non-alcoholic, low fat, low calorie, and low or no sugar.

16. The ordering system according to any previous claim, wherein the server is further configured to present advertisements on the mobile device together with the menu of products.

17. The ordering system according to any previous claim, wherein the server is further configured to provide to the mobile device a calorie count of the one or more selected products.

18. The ordering system according to any previous claim, wherein the communication further contains a table or location identifier to receive the ordered products.

19. The ordering system according to any previous claim, wherein the server is further configured to restrict the menu of products to those products currently available and/or in stock.

20. The ordering system according to any previous claim, wherein the mobile device is selected from the group consisting of: cell phone, smartphone, tablet computer, and laptop computer.

21. The ordering system according to any previous claim, wherein the user is a consumer of the one or more products.

22. The ordering system according to any previous claim, wherein the server is further configured to present a separate web page for separate users such that each separate user may build a separate sub-order of products to be added to the communication.

23. The ordering system of claim 21, wherein each sub-order has an associated cost presented to each separate user.

24. The ordering system according to any previous claim, wherein the server is connectable to the wireless access point over an external network.

25. The ordering system of claim 24, wherein the wireless access point is a public WiFi hotspot.

26. The ordering system of claim 24 or 25 further comprising a payment gateway in communication with the server and configured to process payments initiated by the mobile device.

27. A method for receiving an order from a user, the method comprising the steps of:
transmitting from a wireless access point a menu of products, the menu being renderable on a browser of a mobile device;
receiving from the mobile device a communication including one or more products selected by a user; and
generating an order instruction comprising the selected one or more products.

28. The method of claim 27, wherein the menu of products is transmitted to the wireless access point across a network from a server, and further wherein the order instruction is generated by the server

29. The method of claim 28, wherein the server operates in a cloud-computing environment.

30. A computer program comprising program instructions that, when executed on a computer cause the computer to perform the method of any of claims 27 to 29.

31. A computer-readable medium carrying a computer program according to claim 30.

32. A computer programmed to perform the method of any of claims 27 to 29.
